(19) United States
(12) Patent Application Publication
(10) Pub. No.: US 2011/0261200 A1
(43) Pub. Date: Oct. 27, 2011

(54) METHOD FOR LOCATING A PARKED VEHICLE AND PORTABLE LOCALIZATION DEVICE FOR LOCATING A PARKED VEHICLE

(75) Inventors: Torsten KANNING, Eltville-Erbach (DE); Justus ILLIUM, Mainz (DE); Ralf SCHOLLMEYER, Bickenbach (DE)

(73) Assignee: GM GLOBAL TECHNOLOGY OPERATIONS LLC, Detroit, MI (US)

(21) Appl. No.: 13/095,543

(22) Filed: Apr. 27, 2011

(30) Foreign Application Priority Data
Apr. 27, 2010 (DE) 102010018332.6

(51) Int. Cl. H04N 7/18; G06K 9/00; G08G 1/123

(52) U.S. Cl. 348/148; 340/989; 382/105; 348/E07.085

(57) ABSTRACT

A method is provided for locating a parked vehicle that includes, but is not limited to determination of information about the location of the vehicle, transmission of the information to a portable localization device, and storage of the information in the localization device for later retrieval of the information. The information about the environment of the vehicle is also determined and transmitted to the portable localization device, such as a mobile terminal.

### CROSS-REFERENCE TO RELATED APPLICATION

This application claims priority to German Patent Application No. 102010018332.6, filed Apr. 27, 2010, which is incorporated herein by reference in its entirety.

### TECHNICAL FIELD

The technical field relates to a method for locating a parked vehicle, in particular to a method in which both information about the location of the vehicle as well as information about the environment of the vehicle are invoked in order to locate the vehicle, and to a portable localization device, to which this information is transmitted and with which the information can be retrieved.

### BACKGROUND

Something that almost everyone has experienced at some time is going shopping or attending a concert, and then being unable to find their own vehicle again anywhere. This happens in particular when parking in strange cities, on giant stadium parking lots or in confusing multi-story parking garages. The simplest option for avoiding this problem is that the vehicle owner notes down the location of his vehicle by hand on a piece of paper, such as a parking ticket or a tear-off slip. The driver can also say the location of his vehicle into a speech recording system, such as those available in the form of key rings with sufficient storage capacity for the purpose. A point of consideration here however is the convenience of the driver. These options are also disadvantageous when there is pressure of time and with regard to the resources required, such as for example pen and paper, which are not available in every vehicle.

To simplify their operation modern vehicles are equipped with more and more electronic gadgets. In many vehicles such things as a GPS navigation system can be found, which supplies some information relating to the approximate location of the vehicle. This system is based on satellites which constantly broadcast their current position and the precise time of day with coded radio signals, from which special GPS receivers can then calculate their own position and speed and can therefore supply information about the approximate location of the vehicle.

In document DE 600 29 881 T2 it is proposed to exploit this information to locate a parked vehicle. The information is transmitted to a portable localization device, such as for example a key handle, on which the information can be stored and retrieved by the driver when required. This system however proves to be disadvantageous in, among other places, large parking garages with multiple parking levels arranged on top of one another, since no information about the parking level on which the vehicle has been left can be obtained from the GPS data.

In conditions where urban space is in short supply, this problem becomes increasingly important, since more and more multi-story parking garages are being built, in particular in inner cities and at airports.

In view of the foregoing, it is desirable to provide a method for locating a parked vehicle, which is designed to be efficient and effective without the driver himself taking an active part. In addition, other desirable features and characteristics will become apparent from the subsequent summary and detailed description, and the appended claims, taken in conjunction with the accompanying drawings and this background.

### SUMMARY

According to an embodiment, a method for locating a parked vehicle is specified, which comprises the steps of determination of information about the location of the vehicle, transmitting the information to a portable localization device, and storage of the information in the localization device. The information about the environment of the vehicle is also determined and transmitted to the portable localization device, which is a mobile terminal, in order to be able to retrieve the information when required.

The steps to determine information about the location of the vehicle and information about the environment of the vehicle can be carried out in any desired sequence, which means it is possible to first determine information about the location of the vehicle and then information about the environment of the vehicle, or to first determine information about the environment of the vehicle and then information about the location of the vehicle, or also to execute both steps simultaneously.

The method, as well as the information about the location of the vehicle, also uses data from the surroundings of the vehicle in order to locate this. It therefore makes it possible for a parked vehicle to be located more precisely in the multi-story parking garage, and therefore more effectively, which means the search for the vehicle is simplified in favor of improved customer convenience. The information about the environment of the vehicle can be used to determine the parking level on which the vehicle is parked and these data, in addition to the information about the location of the vehicle, which can be common to the multiple parking levels arranged on top of one another, can be used to locate the vehicle. The use of a mobile terminal enables data to be transmitted between the vehicle and the mobile terminal via a radio link in real time and therefore to optimize access to the information stored in the vehicle or made available to the driver and to structure it in the simplest possible manner. Here, the additional information in the vicinity of the vehicle leads to a faster and simpler location of the vehicle, since as well as the information relating to the location of the vehicle, the driver has access to information relating to the environment of the vehicle at all times, and therefore to the parking level on which the vehicle has been parked.

In one embodiment the information on the location of the vehicle is obtained from GPS data. The mode of operation of GPS navigation systems is such that the instantaneous position of the vehicle, which is calculated by means of a GPS and therefore based on satellites, can be determined almost exactly in real time. Furthermore, the information about the environment of the vehicle can be obtained with a camera for license plate recognition and/or a camera positioned on the side of the vehicle, or a camera system of a reverse parking sensor. Such camera systems are known from the prior art and can be extended in such a manner that they can be used more universally, that is to say, in particular for different observation regions and purposes, without new camera systems, both technically elaborate as well as financially costly, needing to be developed and installed. Therefore, using camera systems already installed in the vehicle, usable information about the environment of the vehicle can be obtained and the location of a parked vehicle can therefore take place more efficiently without substantial additional financial cost and the driver can be provided with an exact parking position. Moreover, other camera systems already present on the vehicle can be used in addition, in order to obtain information about the immediate environment of the vehicle.

The information about the environment of the vehicle obtained by means of the camera for license plate recognition can be the number and level of the parking space in which the vehicle was parked. By means of cameras positioned on the side of the vehicle, or the camera system of a reverse parking sensor, parking space identification signs can be recorded. These enable the parking space and therefore the current position of the vehicle to be identified, and the vehicle to be rapidly located once the information is retrieved, since this information is made available to the driver in addition to the information about the location. The process of locating the vehicle can thereby be further improved, since an exact parking position of the vehicle is provided to the driver.

In another embodiment, the process of determining the information about the location of the vehicle and/or the environment of the vehicle can be started by activating a button. This button can be integrated into the navigation system, arranged on another part of the vehicle console that is biomechanically convenient to reach, as well as on the portable localization device. The activation of the button triggers the determination and collection of information about the location and the environment of the vehicle and thus the transmission of vehicle location information to the portable localization device. The operating method used is simple and intuitive to learn, which means that the operating procedures are simplified and overall, unnecessary sequences of movements are avoided in favor of improved convenience of the functions.

In another embodiment, the determination of information about the location of the vehicle and/or the environment of the vehicle can be started by spoken input. This can be achieved by e.g. the spoken input of key words, to each of which functions are assigned in a context dependent manner. This means that when reverse parking, which represents a difficult maneuver both for learner drivers as well as for many experienced drivers, the driver is no longer distracted by additional hand controls.

The launching of the information gathering procedure can thus be repeated as often as desired and the method can therefore be configured as individually as possible. In addition, the determination of information about the location and/or the environment of the vehicle can also be launched by other events. Thus, this can also take place passively, for example when closing the vehicle doors.

The information so determined can be transmitted via SMS, Blue Tooth, radio or via a mechanical-electrical interface to the mobile terminal. This facilitates a standardized, error-resistant data transfer using standard commercial and therefore inexpensive components, without these needing to be modified. Cost-effective data channels such as GSM, GPRS, WLAN and the like can thus be deployed for data transfer, without having to pay any extra fee for the service. Also, a faster data transmission is guaranteed over a greater range.

The information transmitted in this way can be the city, street and house number, the parking level, color of the parking level and also the number of the parking space. In this manner all relevant and essential items of information about the parking space can be used and made available to an automatic post-processing stage. This means that a further improvement in the efficiency of the method is obtained.

In addition, other noticeable and correspondingly distinguishing features of the environment can be invoked, detected and further processed, such as for example, license plate numbers or perhaps the ambient light.

A portable localization device is also provided in accordance with an embodiment for locating a parked vehicle, by means of which the method described above can be implemented, is also specified. The portable localization device here comprises a receiver unit for receiving information from transmitter units arranged on the vehicle, a display unit for displaying the received information and a storage unit for storing the received information. The portable localization device can further process information about both the location of the vehicle as and about the environment of the vehicle. In addition to the location, which can be the same for multiple parking levels arranged on top of one another, information about the environment of the vehicle, that is to say the appropriate parking level, is further processed and made available to the driver when required, together with the information about the location of the vehicle, without the driver having to use more than one device. By storing the different items of information on a localization device, the driver is provided with positioning information which, even in parking garages with multiple parking levels arranged on top of one another, can take him very close to his vehicle. The efficiency of the method is thereby further increased, without extra costs arising due to the use of additional or larger devices.

In one embodiment, the portable localization device is a display device that can be connected to the vehicle, such as e.g., a media carrier, a mobile phone, a Blackberry or a Smartphone. Hence, to implement the automated technical process a data carrier is used, with which images and other data can be simultaneously displayed. In this way, the display device can be used to display an image of the region in the immediate environment of the vehicle, which is photographed with the camera system. Simultaneously the display device can be provided with location information from the vehicle, which means that the driver is reminded of the location of the vehicle and is able to find it, and therefore the effectiveness of the vehicle location process is increased.

In summary, it should be noted that with the present invention the efficiency and the effectiveness of locating a parked vehicle can be increased. By using information about the environment of the vehicle as well as the position of the vehicle, other information also combines to influence the vehicle location process, such as for example information about the parking level, which proves particularly advantageous in large parking garages with multiple parking levels arranged on top of one another. These data about the environment of the vehicle can be obtained with already known camera systems integrated in the vehicle, and therefore in a cost-effective manner. The storage of this data can be easily and intuitively affected by activation of a button, by speech input or al-so by passive means. The use of a mobile terminal enables the driver to access the information in real time, since images which can be photographed with a camera system can be accessed at the same time as other data, such as for example information about the location of the vehicle.

At least one objective is achieved with these embodiments as the driver is provided with location information about his parked vehicle, even in large multi-story parking garages. The driver is also provided with an exact position of the parked vehicle in real time on a display device connected to the vehicle, in order to simplify the search for the vehicle in favor of improved customer convenience. In this manner the driver can be reminded of the location of the vehicle when required and can find the vehicle without having to search for long periods and therefore having to be active himself.

### BRIEF DESCRIPTION OF THE DRAWINGS

The present invention will hereinafter be described in conjunction with the following drawing figures, wherein like numerals denote like elements, and:

FIG. 1 shows a flow diagram of the method for locating a parked vehicle according to one embodiment;

FIG. 2 shows a schematic illustration of essential method steps of the method according to an embodiment.

### DETAILED DESCRIPTION

The following detailed description is merely exemplary in nature and is not intended to limit application and uses. Furthermore, there is no intention to be bound by any theory presented in the preceding background or summary or the following detailed description.

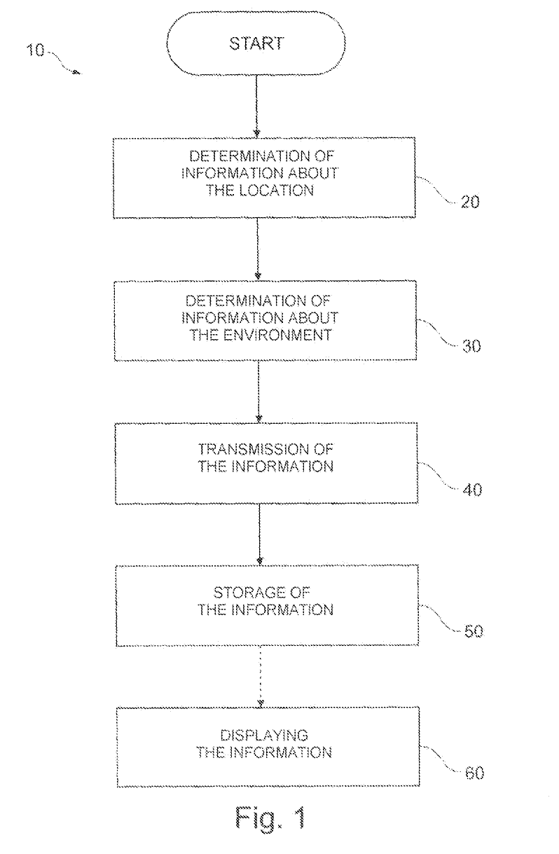

FIG. 1 shows a flow diagram of a method 10 for locating a parked vehicle according to one embodiment. The method comprises the following steps: as shown in FIG. 1, information about the location of the vehicle 20 and information about the environment of the vehicle is determined 30, the information is transmitted to a mobile terminal 40, on which the information is stored 50. Optionally the information can be retrieved 60 by the driver via the mobile terminal as required.

The execution of the steps of determination of information about the location 20 and determination of information about the environment 30 can take place in any desired sequence, i.e., it is possible to first determine information about the location 20 and then to determine information about the environment of the vehicle 30, or to first determine information about the environment of the vehicle 30 and then to determine information about the location 20, or also to execute both steps 20, 30 simultaneously, deviating from the exemplary embodiment shown here.

In the exemplary embodiment shown, information about the location of the vehicle is first determined 20, which can be obtained very accurately from GPS data. The information about the environment of the vehicle can be obtained 30 with known camera systems, already integrated into the vehicle. Included in this are a camera for license plate recognition, cameras positioned on the side of the vehicle, or a camera system of a reverse parking sensor. Thus, signs which indicate the number and level of a parking space can be detected and recorded using the license plate recognition camera, and parking space identification signs detected and recorded using the camera positioned on the side of the vehicle or the camera system of a reverse parking sensor, in addition to the information about the location of the vehicle. Moreover, other camera systems already present on the vehicle can be used in addition, in order to obtain information about the immediate environment of the vehicle.

The determination of the information in this case can be started by activation of a button which is attached to the GPS navigation system, to another point of the vehicle console that is biomechanically convenient to reach, or to the portable localization device. The determination process can also be started by speech input, so that the driver can concentrate on the reverse parking, which represents a difficult maneuver both for learner drivers as well as for many experienced drivers. Furthermore, the determination of the information can also be passively started, when a procedure occurs on the vehicle, such as the closure of the vehicle doors.

In a next step this information is transmitted to a portable localization device 40, which is a mobile terminal, in order to be able to retrieve the information when required. The information so determined can be transmitted via SMS, Blue Tooth, radio or via a mechanical-electrical interface to the mobile terminal. The information transmitted can include the city, the street and house number, the parking level and also the color of the parking level and the number of the parking space. In addition, other noticeable and correspondingly distinguishing features of the environment can be invoked, detected and further processed, such as for example, registration numbers or perhaps the ambient light.

In a further step the transmitted data are stored on the mobile terminal 50, which as well as a receiver unit for receiving information from transmitter units arranged on the vehicle and a display unit for displaying the received information, also comprises a storage unit for storing the received information. Optionally the stored information can be displayed to the driver 60 when required. This optional step is indicated in FIG. 1 by a dashed line. In this way, an image of the region in the immediate environment of the vehicle, which has been photographed with the camera system, can be displayed with the display unit. Simultaneously the driver can be provided with location information of the parked vehicle, obtained for example using a GPS navigation system.

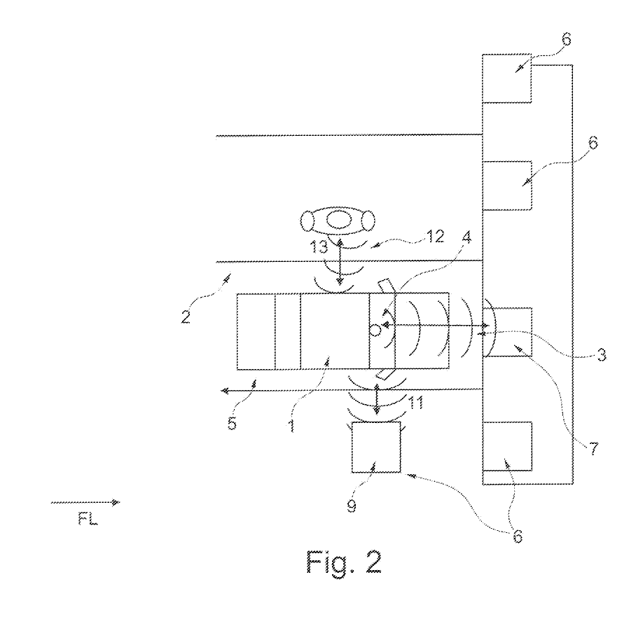

FIG. 2 shows a schematic illustration of steps of the method 10 according to an embodiment. Here a vehicle 1 can be seen, which has been parked in a parking space 2. The longitudinal direction of the vehicle is labeled in FIG. 2 by an arrow FL. The vehicle has a GPS navigation system (not shown), which communicates with a satellite (not shown), interprets the satellite signal and can thus determine the approximate location of the vehicle 1. FIG. 2 further shows a camera for license plate recognition 4 mounted on the vehicle front 3. In addition the vehicle 1 has cameras (not shown) mounted on its sides in the region of the wing mirrors. In addition, other camera systems already present on the vehicle can also be used to obtain information about the immediate environment of the vehicle, such as for example a camera of a reverse parking sensor system mounted in the region of the vehicle trunk 5.

By means of the license plate recognition camera 4 and the camera mounted on the side of the vehicle 1, information about the environment of the vehicle 1 can be additionally obtained. Thus, the region directly in front of the vehicle 1 can be photographed with the license plate recognition camera 4 and information about signs 6 appearing in this region, such as for example about the number 7 and the level of a parking space 2, can be obtained. In relation to the vehicle the viewing direction of the license plate recognition camera is defined by the arrow 8 labeled with the reference mark. By means of the camera mounted on the side of the vehicle 1, signs and important signals, such as for example parking space identification signs 9 around the periphery of the vehicle 1, can be moved into the field of view. In relation to the right-hand wing mirror 14 of the vehicle 1 in the longitudinal direction FL of the vehicle, the viewing direction of the camera mounted there is identified by the arrow labeled with reference mark 11. In addition, other noticeable and correspondingly distinguishing features of the environment can also be invoked, detected and further processed, such as, for example, license numbers or perhaps the ambient light.

The information about the environment of the vehicle 1 thus obtained can then be transmitted together with the information about the location of the vehicle 1 to a portable localization device 12. The arrow labeled with reference mark 13 symbolizes the data transfer between the individual components of the vehicle 1 and the portable localization device 12. The information can be transmitted via SMS, Blue Tooth, radio or via a mechanical electrical interface. The information is stored on the portable localization device 12, which is a mobile terminal, such as for example a media carrier, a mobile phone, a Black Value or a Smartphone, so that the driver can retrieve them at any time when required.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

What is claimed is:

1. A method for locating a parked vehicle, comprising:
determining information about a location of the parked vehicle;
transmitting the information to a portable localization device;
storing the information in the portable localization device;
determining environment information about an environment of the parked vehicle; and
transmitting the environment information to the portable localization device for retrieval in locating the parked vehicle.

2. The method according to claim 1, wherein the information about the location of the parked vehicle is obtained from GPS data.

3. The method according to claim 1, wherein the environment information about the environment of the parked vehicle is obtained with a camera for license plate recognition.

4. The method according to claim 1, wherein the environment information about the environment of the parked vehicle is obtained with a camera positioned on a side of the parked vehicle.

5. The method according to claim 1, wherein the environment information about the environment of the parked vehicle is obtained with a camera for reverse parking.

6. The method according to claim 1, wherein a number and a level of a parking space are recorded with a camera for license plate recognition, and parking space identification marks are recorded with a second camera positioned on the parked vehicle.

7. The method according to claim 1, wherein the determining the information about the location of the parked vehicle comprises starting upon reception of an activation request received from an input device.

8. The method according to claim 7, wherein the input device is a button.

9. The method according to claim 1, wherein the determining the environment information about the environment of the parked vehicle comprises starting upon reception of an activation request from an input device.

10. The method according to claim 9, wherein the input device is a speech recognition device.

11. The method according to claim 7, wherein the information comprises city, street number, house number, a parking level, and a number of a parking space.

12. A portable localization device for locating a parked vehicle, comprising:
a receiver unit configured to receive information about a location of parked vehicle from a transmitter of the parked vehicle and configured to receive environmental information about an environment of the parked vehicle;
a display unit configured to display the information and the environmental information;
a storage unit configured to store the information and the environmental information; and
a processor configured to process both the information and the environmental information of the parked vehicle to provide a location of the parked vehicle.

13. The portable localization device according to claim 12, wherein the portable localization device is a media carrier.

14. The portable localization device according to claim 12, wherein the portable localization device is a mobile phone.

15. The portable localization device according to claim 12, wherein the portable localization device is a Blackberry.

16. The portable localization device according to claim 12, wherein the portable localization device is a Smartphone.

17. The portable localization device according to claim 12, wherein the receiver unit is configured to receive the information about the location of the parked vehicle from GPS data.

18. The portable localization device according to claim 12, wherein the receiver unit is configured to receive the environmental information about the environment of the parked vehicle from a camera for license plate recognition.

19. The portable localization device according to claim 12, wherein the receiver unit is configured to receive the environmental information about the environment of the parked vehicle from a camera positioned on a side of the parked vehicle.

20. The portable localization device according to claim 12, wherein the receiver unit is configured to receive the environmental information about the environment of the parked vehicle from a camera for reverse parking.
